(19) United States
(12) Patent Application Publication
(10) Pub. No.: US 2014/0215110 A1
(43) Pub. Date: Jul. 31, 2014

(54) DRIVING INTEGRATED CIRCUIT AND UPATE METHOD THEREOF

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YANG WANG, Shenzhen (CN); JUN-JUAN GAO, Shenzhen (CN); XIAO-WEI YANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/159,440

(22) Filed: Jan. 21, 2014

(30) Foreign Application Priority Data
Jan. 30, 2013 (CN) 2013100356721

(51) Int. Cl. G06F 13/38

(52) U.S. Cl. CPC G06F 13/387
USPC 710/105

(57) ABSTRACT

A driving IC is being controlled by a host IC to update a driving program stored in a storage with a SPI interface. The driving IC includes a IIC interface, an identifying module, and a calculating module. The IIC interface receives an instruction from the host IC in the IIC protocol format. The identifying module determines whether the received instruction is an update instruction, and generates a converting instruction when the received instruction is the update instruction. The calculating module converts the received instruction into a SPI format according to a predetermined converting rule. The SPI interface transmits the converted instruction in the SPI format to the storage.

### BACKGROUND

1. Technical Field

The present disclosure relates to communication technology, and particularly to a driver integrated circuit (IC) and method for updating a driving program for single program initiation (SPI) interface using an inter-IC communication (IIC) protocol.

2. Description of Related Art

A liquid crystal display (LCD) is driven by a timing controller (T-Con) IC. T-con IC includes an IIC interface and a SPI interface. A program executed by the T-con IC is stored in a flash storage which is using the SPI interface. T-con IC receives a driving command from a host IC via the IIC interface, and responds to the driving command by calling the program via the SPI interface to drive the LCD to display. However, the host IC does not contain a SPI interface and cannot directly access the flash storage. Thus, the host IC cannot update the program for the T-con IC stored in the flash IC.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 shows a functional block of the displaying system with a driving IC.

FIG. 2 shows a functional block of the driving IC in FIG. 1.

FIG. 3 shows flowchart of a method for updating a driving program.

### DETAILED DESCRIPTION

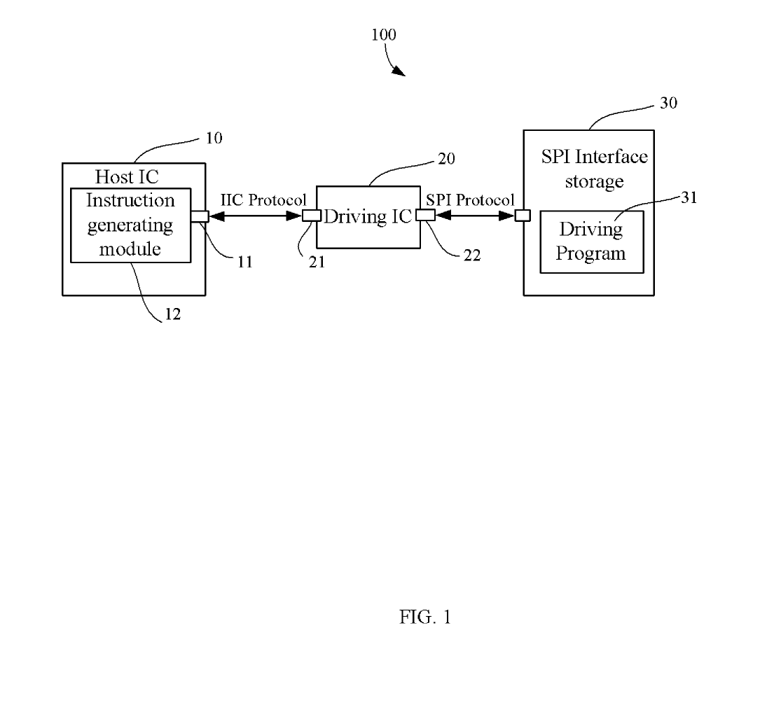

FIG. 1 shows an embodiment of a display system 100. The display system 100 includes a host IC 10, a driving IC 20, and a storage 30 with an SPI interface. The host IC 10 communicates with the driving IC 20 via an IIC protocol. The driving IC 20 communicates with the storage 30 via a SPI protocol. In this embodiment, the driving IC 20 is a T-con IC for driving an LCD screen (not shown). The driving IC 20 includes a driving program stored in the storage 30. The driving IC 20 is controlled by the host IC 10 to call the program 31 in the storage 30 to drive the LCD screen. In this embodiment, the storage 30 is a flash storage.

The host IC 10 includes an IIC interface 11 and an instruction generating module 12. The instruction generating module 12 responds an operation to generate a drive instruction to drive the driver IC 20, and an update instruction to update the program 31. The driving instruction and the update instruction are both in an IIC protocol format. The update instruction includes a written instruction, a read instruction and a stop instruction. In detail, the written instruction is Start+IDw+10h+W1+data1+stop; the read instruction is “Start+IDw+10h+W1+stop and Start+IDw+11h+Start+IDr+data2+stop”; the stop instruction is “Start+IDw+12h+stop”. The 10h, 11h, and 12 h signals are respectively considered as identifying signals of the written, read, and stop instructions.

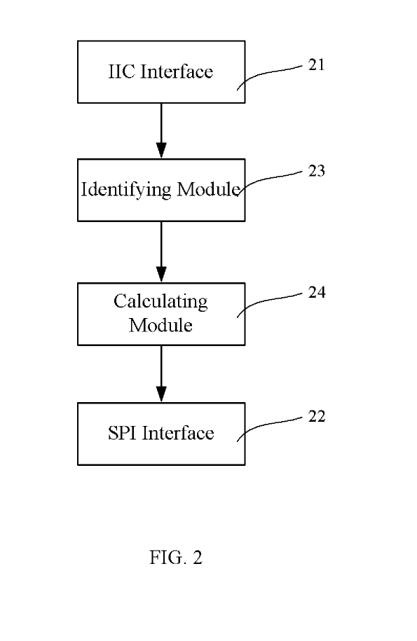

FIG. 2 shows an embodiment of the driver IC 20. The driver IC includes an IIC interface 21, a SPI interface 22, an identifying module 23, and a calculating module 24.

The IIC interface 21 receives a signal in the IIC protocol format from the host IC 10. The identifying module 23 determines whether the received signal in the IIC protocol format is the update instruction, and identifies whether the update instruction is the written instruction, the read instruction, or the stop instruction. In detail, when the identifying module 23 identifies that the received signal includes the 10h signal but does not includes the 11h signal, the identifying module 23 determines that the received signal is the written instruction. When the identifying module 23 identifies that the received signal includes the 10h and the 11h, the identifying module 23 determines that the received signal is the read instruction. When the identifying module 23 identifies that the received signal includes the 12h signal, the identifying module 23 determines that the received signal is the stop instruction.

The calculating unit 24 converts the update instruction, such as the written, the read, and the stop instruction in the IIC protocol format into a written, read, and the stop instructions in the SPI protocol format according to a predetermined converting rule, and transfers the update instruction in the SPI format to the storage 30 via the SPI interface 22. The written instruction in the SPI protocol format is “S_B_low+W1+data1”; the read instruction in the SPI protocol format is “S_B_low+W1+data1+data2” and the stop instruction in the SPI protocol format is “S_B_high”.

When the received signal is the written instruction in the IIC protocol format, the calculating module 24 converts the “Start+IDw+10h”signal into “S_B_low” signal of the written instruction in the SPI protocol format, converts the “W1” signal into the “W1” signal of the written instruction in the SPI protocol format, and converts “data1” signal into the “data 1” signal of the written instruction in the SPI protocol format.

When the received signal is the read instruction in the IIC protocol format, the calculating module 24 converts the “Start+IDw+10h”signal into “S_B_low” signal of the read instruction in the SPI protocol format, converts the “W1” signal into the “W1” signal of the read instruction in the SPI protocol format, and converts “data 1” signal into the “data 1” signal of the read instruction in the SPI protocol format, and converts the “data 2” signal into the “data 2” signal of the read instruction in the SPI protocol format.

When the received signal is the stop instruction in the IIC protocol format, the calculating module 24 converts the “Start+IDw+12h+stop” signal into “S_B_high” signal of the stop instruction in the SPI protocol format.

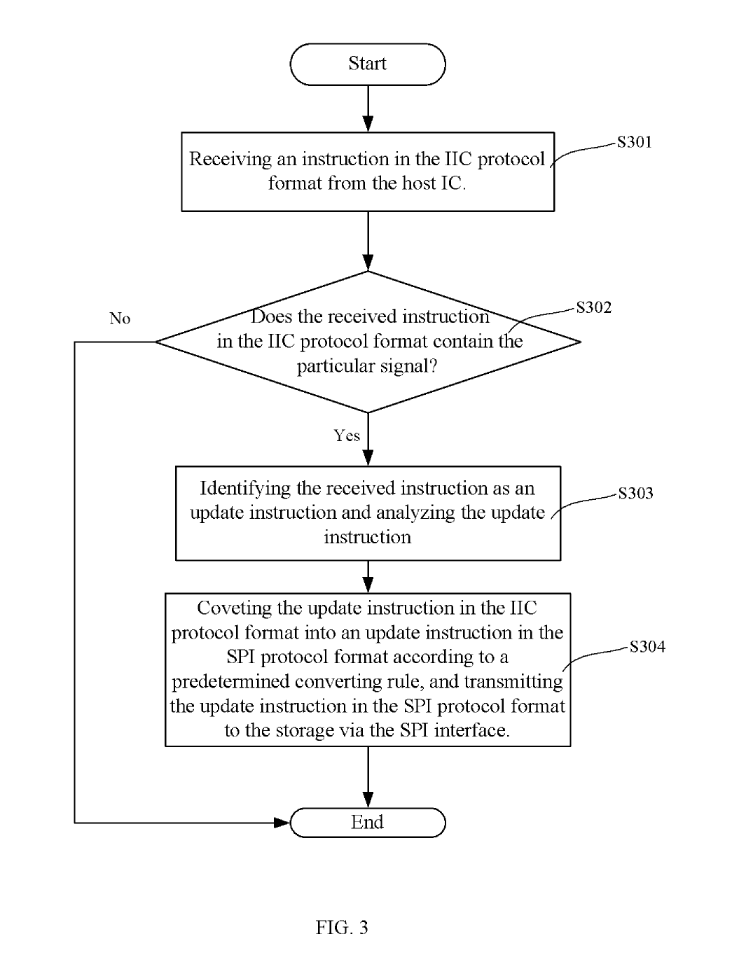

FIG. 3 shows an embodiment of a flowchart of an updating method executed by a driver IC for updating the driving program of the driver IC. The driving program is stored in a storage with a SPI interface. The driver IC communicates with a host IC. The updating method includes the following steps.

Step S301: receiving an instruction in the IIC protocol format from the host IC.

Step S302: determining whether the received instruction in the IIC protocol format contains the identifying signal. When the instruction in the IIC protocol format contains the identifying signal, the process goes to step S303, otherwise the process is ended.

Step S303: identifying the received instruction as an update instruction and analyzing the update instruction.

Step S304: converting the update instruction in the IIC protocol format into an update instruction in the SPI protocol format according to a predetermined rule, and transmitting the update instruction in the SPI protocol format to the storage via the SPI interface.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A driving integrated circuit (IC), being controlled by a host IC to update a driving program stored in a storage with a single program initiation (SPI) interface, the driving IC comprising:
an inter-IC (IIC) interface to received an instruction from the host IC in the IIC protocol format;
an identifying module to determine whether the received instruction is an update instruction, and generate a converting instruction when the received instruction is the update instruction; and
a calculating module to convert the received instruction into an SPI format according to a predetermined converting rule; and
an SPI interface to transmits the converted instruction in the SPI format to the storage.

2. The driving IC of claim 1, wherein the identifying determines whether the received signal is the update signal based on a identifying signal contained in the update instruction.

3. The driving IC of claim 2, wherein the update instruction includes a written instruction in the IIC protocol format, the calculating module converts the written instruction in the IIC protocol format into a written instruction in the SPI protocol format according to the predetermined converting rule, the written instruction in the IIC protocol format is Start+IDw+10h+W1+data1+stop, the written instruction in the SPI protocol format is S_B_low+W1+data1, the 10h signal is the identifying signal of the written instruction in the IIC protocol format, the identifying module identifies the written instruction based on the 10h signal, the calculating module converts the Start+IDw+10h signal of the written instruction in the IIC protocol format into the S_B_low signal of the written instruction in the SPI protocol format, converts the W1 signal of the written instruction in the IIC protocol format into the W1 signal of the written instruction in the SPI protocol format, and converts the data1 signal of the written instruction in the IIC protocol format into the data1 signal of the written instruction in the SPI protocol format.

4. The driving IC of claim 2, wherein the update instruction includes a read instruction in the IIC protocol format, the calculating module converts the read instruction in the IIC protocol format into a read instruction in the SPI protocol format according to the predetermined converting rule, the read instruction in the IIC protocol format is Start+IDw+10h+W1+data1+stop and Start+IDw+11h+Start+IDr+data2+stop, the read instruction in the SPI protocol format is S_B_low+W1+data1+data2, the 10h signal and the 11h signal are the identifying signals of the read instruction in the IIC protocol format, the identifying module identifies the read instruction based on the 10h and the 11h signal, the calculating module converts the Start+IDw+10h signal of the read instruction in the IIC protocol format into the S_B_low signal of the read instruction in the SPI protocol format, converts the W1 signal of the read instruction in the IIC protocol format into the W1 signal of the read instruction in the SPI protocol format, converts the data1 signal of the read instruction in the IIC protocol format into the data1 signal of the read instruction in the SPI protocol format, and converts the data2 signal of the read instruction in the IIC protocol format into the data2 signal of the read instruction in the SPI protocol format.

5. The driving IC of claim 2, wherein the update instruction includes a stop instruction in the IIC protocol format, the calculating module converts the stop instruction in the IIC protocol format into a stop instruction in the SPI protocol format according to the predetermined converting rule, the stop instruction in the IIC protocol format is Start+IDw+12h+stop; the stop instruction in the SPI protocol format is S_B_high, the 12h signal is the identifying signals of the stop instruction in the IIC protocol format, the identifying module identifies the stop instruction based on the 12h signal, and the calculating module converts the Start+IDw+12h+stop signal of the stop instruction in the IIC protocol format into the S_B_high signal of the stop instruction in the SPI protocol format.

6. An updating method, being executed by a driving (IC) to update a driving program stored in a storage with a single program initiation (SPI) interface, the driving program being called by the driving IC in response to a driving instruction from a host IC, the update method comprising steps of:
receiving an instruction in a an inter-IC (IIC) protocol format from the host IC;
determining whether the received instruction in the IIC protocol format is an update instruction;
converting the received instruction in the IIC protocol format into SPI protocol format according to a predetermined converting rule when the received instruction in the IIC protocol format is the update instruction; and
transmitting the update instruction in the SPI protocol format to the storage via the interface to control the driving program to update.

7. The update method of the claim 6, wherein the step of determining whether the received instruction in the IIC protocol format is the update instruction comprising the steps of:
determining whether the received instruction in the IIC format; and
determining the received instruction is the update instruction when the received instruction in the IIC format contains a predetermined identifying signal.

8. The update method of claim 7, wherein the update instruction includes a written instruction in the IIC protocol format, the written instruction in the IIC protocol format is Start+IDw+10h+W1+data1+stop, the written instruction in the SPI protocol format is S_B_low+W1+data1, the 10h signal is the identifying signal of the written instruction in the IIC protocol format, the update method identifies the written instruction based on the 10h signal, the step of converting the written instruction in the IIC protocol format into the SPI protocol format comprising the steps of:
converting the Start+IDw+10h signal of the written instruction in the IIC protocol format into the S_B_low signal of the written instruction in the SPI protocol format; and
converting the W1 signal of the written instruction in the IIC protocol format into the W1 signal of the written instruction in the SPI protocol format; and converting the data1 signal of the written instruction in the IIC protocol format into the data1 signal of the written instruction in the SPI protocol format.

9. The update method of claim 7, wherein the update instruction includes a read instruction in the IIC protocol format, the read instruction in the IIC protocol format is Start+IDw+10h+W1+data1+stop and Start+IDw+11h+Start+IDr+data2+stop, the read instruction in the SPI protocol format is S_B_low+W1+data1+data2, the 10h signal and the 11h signal are the identifying signals of the read instruction in the IIC protocol format, the update method identifies the read instruction based on the 10h and the 11h signal, the step of converting the read instruction in the IIC protocol format into the SPI protocol format is that:
converting the Start+IDw+10h signal of the read instruction in the IIC protocol format into the S_B_low signal of the read instruction in the SPI protocol format;
converting the W1 signal of the read instruction in the IIC protocol format into the W1 signal of the read instruction in the SPI protocol format;
converting the data1 signal of the read instruction in the IIC protocol format into the data1 signal of the read instruction in the SPI protocol format; and
converting the data2 signal of the read instruction in the IIC protocol format into the data2 signal of the read instruction in the SPI protocol format.

10. The update method of claim 6, wherein the update instruction includes a stop instruction in the IIC protocol format, the stop instruction in the IIC protocol format is Start+IDw+12h+stop; the stop instruction in the SPI protocol format is S_B_high, the 12h signal is the identifying signals of the stop instruction in the IIC protocol format, the update method identifies the stop instruction based on the 12h signal, the step of converting the stop instruction in the IIC protocol format into the stop SPI instruction is that converting the Start+IDw+12h+stop signal of the stop instruction in the IIC protocol format into the S_B_high signal of the stop instruction in the SPI protocol format.
